(19) United States
(12) Patent Application Publication
(10) Pub. No.: US 2001/0014102 A1
(43) Pub. Date: Aug. 16, 2001

(54) ISOCHRONOUS PIPES CHANNEL MAPPING

(76) Inventors: DORIS ANN MATTINGLY, HUNTINGTON BEACH, CA (US); JOSEPH MICHAEL HANSEN, LONG BEACH, CA (US)

Correspondence Address: RAYMOND VAN DYKE, JENKENS & GILCHRIST, 3200 FOUNTAIN PLACE, 1445 ROSS AVENUE, DALLAS, TX, 752022799

(21) Appl. No.: 09/160,370

(22) Filed: Sep. 24, 1998

(51) Int. Cl. H04L 12/56

(52) U.S. Cl. 370/421; 370/468

(57) ABSTRACT

Improved methods and arrangements are provided for supporting multiple simultaneous isochronous data transfers in a stream pipe of a Universal Serial Bus (USB). The stream pipe is subdivided into a plurality of channels. Devices requiring isochronous data transfers over the USB are dynamically assigned to use a particular channel as defined and mapped using a channel assignment message. In this manner, a plurality isochronous data transfers can be accomplished simultaneously within a single stream pipe. The improved methods and arrangements can be advantageously applied to computer telephony systems that need to support a plurality of user access devices and/or connect to multiple external telephone lines.

### BACKGROUND OF THE INVENTION

1. Technical Field of the Invention

The present invention relates to computer systems, and more particularly to methods and arrangements that allow a plurality of devices to share one or more isochronous pipes in a Universal Serial Bus (USB) configuration.

2. Description of Related Art

A recent entry into the personal computer (PC) world is the Universal Serial Bus (USB). A USB is typically used to connect peripheral devices to a PC. USB supports data transmission rates of over 10 Mbits/s, and as such is suitable for supporting real-time video and/or audio applications.

Moreover, USB provides a simple, universal interface for a wide range of USB compliant devices including digital joysticks, scanners, speakers, digital cameras, monitor controllers and, essentially, any other devices traditionally adapted for the various PC interfaces. With USB, these devices all share a common interface and therefore there is a potential for dramatic increases in their interaction and enhanced functionality, especially in light of the high data transmission rates supported by USB.

A particular application that can benefit from USB is computer telephony. Computer telephony is a field of computer and telephony integration in which a PC telephone peripheral provides voice telephony and, through software running on an associated host PC, more advanced services, e.g., management of voice, data and fax mail boxes, call routing services, etc.

Most recently, the personal wireless network, a version of PC telephony, has emerged as a viable communications alternative for the small office and home environments. The personal wireless network is a radio frequency network utilizing a personal computer (PC) as a communications center. The personal wireless network promises to enable the consumer the capability of printing documents, interchanging files and accessing the Internet, regardless of where the PCS, printers and telephone jacks are installed and used. Other electrical systems will also be controlled by the computer. For example, users will be able to arm their alarm system by speaking a simple command into a lightweight cordless telephone handset. In short, the personal wireless network utilizes high speed interfaces, such as the USB, for availing real-time communications in a network essentially all of the abovementioned wireless and wired devices.

One of the challenges with these emerging fields of personal communications exists in providing the necessary isochronous communications required by the different devices and/or interfaces within the wireless network. For example, a wireless network will typically need to support simultaneous transfer of isochronous data from a plurality of analog and/or digital devices, such as, for example, external plain old telephone (POTS) analog devices, external integrated digital services network (ISDN) devices, and internal digital wireless devices.

Data transferred in USB, between a source or destination, is said to be carried over “a pipe”. Basically, there are two types of pipes in USB, namely a stream pipe and a message pipe. Unlike message pipes, the structure of data carried in stream pipes is not specifically defined in the USB specification. Pipes typically come into existence when a USB device is configured. For example, when a USB device is powered on, a message pipe is usually created and designated a control pipe. This control pipe provides access to the device's configuration, status, and control information.

The USB protocol provides for isochronous transfer type, over a stream pipe, that is designed to support isochronous sources and destinations. The few isochronous devices available on the market today are limited to a single data interface, and others, provide a single function. This single function is typically supported using two stream pipes, namely, one stream pipe for incoming data and a second stream pipe for outgoing data. Since there is typically only one source of isochronous data from a given device this approach is reasonable.

However, for a computer telephony system having a plurality of devices/sources for isochronous data, providing a set of pipes for each device/source can be impractical and/or overly complex/expensive. Thus, there is a need for improved methods and arrangements that allow for a plurality of simultaneous isochronous transfers to be conducted over a fewer number of stream pipes in a USB, or like configured system.

### SUMMARY OF THE INVENTION

The present invention provides improved methods and arrangements for use in computer and communications systems, such as, for example, a computer telephony system. In accordance with certain aspects of the present invention, the improved methods and arrangements support multiple simultaneous isochronous data transfers in a stream pipe of a Universal Serial Bus (USB). The stream pipe is subdivided into a plurality of channels. Devices requiring isochronous data transfers over the USB are then dynamically assigned to use a particular channel as defined and mapped, for example, using a channel assignment message. In this manner, a plurality isochronous data transfers can be accomplished simultaneously within a single stream pipe.

The improved methods and arrangements can be advantageously applied to computer telephony systems that need to support a plurality of user access devices and/or connect to multiple external telephone lines.

Thus, in accordance with certain embodiments of the present invention, an arrangement is provided that includes a bus and at least two devices. The bus has at least one stream pipe that is configured to carry isochronous data transfers. Each of the devices is connected to the bus and configured to send and receive the isochronous data transfers over the bus using different logical channels within the stream pipe. The devices can be further configured to be dynamically assigned to use one of a plurality of logical channels as defined within the stream pipe, for example, using a channel assignment message.

The above stated needs and others are also met by an apparatus that can be used to connect to a bus having at least one stream pipe configured to carry isochronous data transfers, wherein the apparatus is configured to selectively send and receive isochronous data transfers over the bus using different logical channels as defined in the stream pipe.

In accordance with still further embodiments of the present invention, a method for supporting multiple simultaneous isochronous data transfers through a stream pipe in a USB is provided. The method includes the steps of dividing a stream pipe into a plurality of channels, and dynamically assigning a first channel to a first device and a second channel to a second device. The method also includes the additional steps of transferring isochronous data within the first channel using the first device, while simultaneously transferring isochronous data within the second channel using the second device.

### BRIEF DESCRIPTION OF THE DRAWINGS

A more complete understanding of the methods and arrangements in accordance with certain embodiments of the present invention may be had by reference to the following detailed description when taken in conjunction with the accompanying drawings wherein:

FIG. 1 is a block diagram depicting a telephony arrangement having a wireless network arrangement that is arranged to provide telephony functions, in accordance with certain embodiments of the present invention;

FIG. 2 is a block diagram depicting an exemplary wireless hub arrangement, as in FIG. 1, having a computer system configured to run a telephony application, a base station device, and at least one user device, in accordance with certain embodiments of the present invention;

FIG. 3 is graphical depiction of data arranged in a stream pipe set (in/out), in accordance with certain embodiments of the present invention; and

FIG. 4 is a graphic depiction of a message that can be passed between connected devices and used to establish the criteria for an isochronous transfer of data over a stream pipe set (in/out), in accordance with certain embodiments of the present invention.

### DETAILED DESCRIPTION OF THE DRAWINGS

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

FIG. 1 is a block diagram depicting a computer telephony system 100 that is arranged to provide voice and/or data communications to a plurality of local users. In order to accomplish this task, computer telephony system 100 includes a hub 102 that is arranged to provide telephony functions to a plurality of users through devices 104a-n. As depicted, hub 102 is depicted as providing wireless communications to a plurality of users, through devices 104a-n. Although not shown, hub 102 can also be arranged to support wired communications to other devices.

As depicted, hub 102 is connected to at least one external network 106 through one or more wire or fiber lines 108. In other embodiments, lines 108 can also include wireless connections. In this manner, computer telephony system 100 is configured to provide telephony services through one or more telecommunications networks. Hub 102, therefore, provides the signal interfacing, switching, monitoring, and controlling functions as required to support the various telephony services, features and operations.

By way of example, in accordance with certain embodiments of the present invention, external network 106 can be any type of communications network that is arranged to provide communications with remote users and/or devices, such as, a public switched telephone network (PTSN). Additionally, external network 106 in certain further embodiments includes or otherwise provides an interface to other external network resources such as an intranet and/or the Internet.

Devices 104a-n can include any type of communication device that is configured for accessing a computer telephony system. By way of example, device 104a can be a wireless telephone or pager type of device, device 104b can be a modem-configured computing device such as a portable computer or personal digital assistant type of device. Devices 104a-n are typically configured to transmit and receive (i.e., exchange) information in the form of either analog or digital data through hub 104, lines 108 and the various resources provided by external network 106.

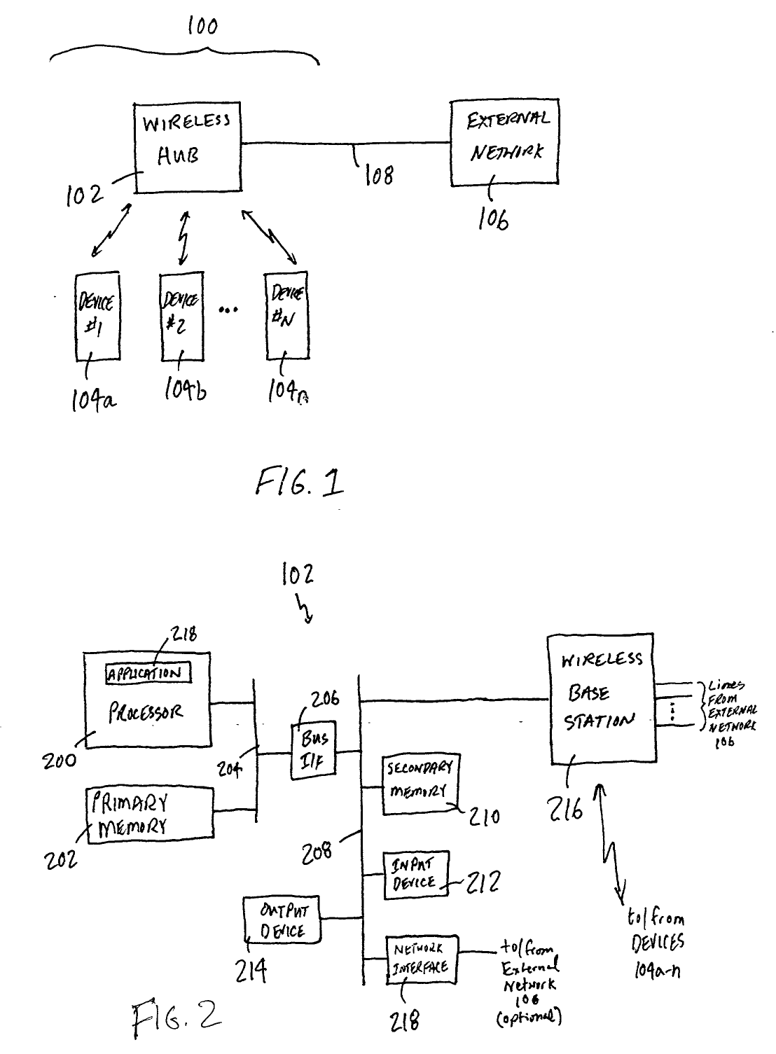

FIG. 2 is a block diagram depicting an exemplary hub 102 that is based primarily on a computer architecture, such as, for example, that found in a contemporary personal computer (PC) or like computer system. Indeed, in accordance with certain preferred embodiments of the present invention, hub 102 includes a conventional PC that is connected to a base station 216 and configured to run one or more telephony applications, including, for example, a telephony application that supports dial by name services.

Referring to the exemplary embodiment depicted in FIG. 2, within hub 102 there is at least one processor 200 that is connected to a primary memory 202 through a first bus 204. Processor 200, for example, can be a microprocessor, such as a Pentium II microprocessor available from Intel Corporation of Santa Clara, Calif. Processor 200 is configured to access primary memory 202 through first bus 204. Primary memory 202 includes random access memory (RAM), such as, dynamic random access memory (DRAM), which is configured to store data associated with at least one telephony application 218 that runs in processor 200.

As shown in FIG. 2, first bus 204 is further interfaced to a second bus 208, through a bus interface (I/F) 206. By way of example, second bus 208 can be a Universal Serial Bus (USB), a Peripheral Component Interconnect (PCI) bus, an Industry Standard Architecture(ISA) bus, or other similar bus. To support isochronous data communications, second bus 208, however, is preferably a USB, or like high-data rate bus, such as, for example, a fire wire bus (IEEE 1394 Standard).

A plurality of devices can be connected to second bus 208. For example, as depicted, a secondary memory 210 can be connected to second bus 208 to provide additional data storage. Secondary memory 210 can include, for example, additional RAM, DRAM, static random access memory (SRAM) (e.g., flash memory), a disk or tape drive and associated magnetic or optomagnetic storage medium, an optical storage drive and optical storage medium, or other like storage device.

At least one input device 212 is also connected to second bus 208 and configured to accept inputs from an operator. Input device 212 can include, for example, a keyboard device, a mouse device, a trackball device, a pen device, a pointing device, a touch sensitive input device, a microphone device, or other like input device. The inputs from input device 212 are then provided to processor 200, application 218, or any of the other applicable connected devices in FIGS. 1 and 2.

At least one output device 214 is also connected to second bus 208. Output device 214 is configured to generate an output suitable for use by a user (with or without additional devices) in response to one or more signals from processor 200. By way of example, output device 214 can include a cathode-ray tube (CRT) generated display, flat panel display, a printer, an audio monitor, or other like devices. In accordance with certain preferred embodiments of the present invention, output device 214 includes a display device such as a CRT or flat panel display.

Hub 102 also includes a base station 216 that is configured to support telephony operations within computer telephony system 100. As shown, base station 216 is connected to second bus 208. Base station 216 includes, for example, a switch matrix and associated processing and/or interface circuitry (not shown). In a wireless hub arrangement 100, such as that depicted in FIG. 1, control device 216 also includes transceiver circuitry that supports the wireless communications to/from devices 104a-n. Base station 216 also provides an interface to lines 108.

Base station 216 is configured to exchange information and to respond to one or more commands from application 218 to selectively control the switch matrix as required to support various telephony operations. To accomplish this, base station 216 is configured to provide status information about the telephony operations, e.g., information about a call, and status information about or from the various devices 104a-n.

An optional network interface device 218 is also connected to second bus 208 to provide additional non-telephony communications between processor 200, for example, a local area network (LAN) (not shown).

Although second bus 208 is depicted as connecting several different devices to first bus 204 and processor 200, it is to be understood that this is only an exemplary configuration, and that certain additional embodiments in accordance with the present invention use a plurality of buses, direct interfaces, and/or shared interfaces between the various devices.

Further, it is to be understood that additional devices can be connected to or otherwise provided in hub 102 as needed to support wired or wireless communications and/or other networking capabilities.

With this exemplary embodiment of a computer telephony system that provides a wireless network capability in mind, the remaining description will focus on improved methods and arrangements for increasing the flexibility of a USB configured computer telephony system to handle simultaneous isochronous data transfers from a plurality of wired and/or wireless devices.

In accordance with certain aspects of the present invention, it was determined during development of a wireless network, such as the one depicted in FIG. 1, that there was a need to use stream pipes to support at least eight simultaneous transfers of isochronous data without requiring dedicated stream channels. The solutions provided herein, however, are flexible enough to apply to other systems/designs, such as, for example, systems having more or fewer devices, and/or different devices with additional communication requirements.

Given these needs, and considering the behavior of contemporary isochronous transfers (for example, as described in the USB specification), it was determined that a specific wireless hub could be supported with 2 sets of stream pipes, wherein each set of stream pipes included an incoming stream pipe (in) and an outgoing stream pipe (out). These stream pipes, however, are not dedicated to any one device or external interface, nor are they restricted to carry data from only one source at a time (i.e., a single transfer). Instead, the stream pipes are shared.

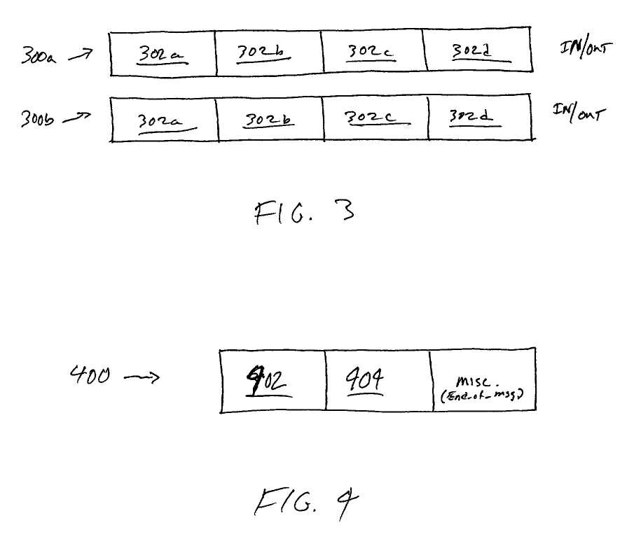

Thus, referring to FIG. 3, in accordance with certain preferred embodiments of the present invention, each stream pipe sets 300a (in/out) and 300b (in/out), for example, is divided into specific number of logical channels 302a-d. Each channel 302a-d is assigned a unique, but general purpose identifier.

When an isochronous transfer is required, for example, from one of the devices 104, then a control message 400, as in FIG. 4 is used to map the source of the isochronous data onto one of the available channels in stream pipes 300a and 300b. The selected channel (e.g., 302a-d) applies to both in/out directions of that pipe set 300a or 300b.

As various isochronous transfers are established/terminated the usage and mapping of the channels on the stream pipes is dynamically assigned. Thus, for example, if there is a need to support eight streams of isochronous data, such as six streams from DECT devices/interfaces and two from PTSN devices/interfaces, then each stream pipe 300a and 300b can be subdivided into four logical channels 302a-d. By providing two sets of stream pipes 300a-b, a total of eight channels for isochronous transactions can be provided. In the past, only two devices could have been supported using two sets of stream pipes.

Each of the devices 104 and external sources (e.g., PTSN interfaces/lines) is also given a unique identifier, which can then be used in message 400 to map a particular source to an individual channel.

By dividing the steam pipes into logical channels 302a-d, and utilizing a generic mapping scheme, the various embodiments of the present invention allow for a more complex and cost effective computer telephony system. Moreover, these improvements can be expanded and applied to larger and/or different system/device configurations in the future. For example, the number of stream pipe sets 300 can be increased/decreased if required, and/or the number of channels 302 can be increased/decreased if required.

As shown in FIG. 3, in accordance with certain preferred embodiments of the present invention, each of the channels 302a-d in stream pipes 300a and 300b is configured to carry eight bytes of voice samples (e.g., in 8-bit PCM format as sampled every millisecond).

Message 400 is used to dynamically select a channel 302a-d for use when streaming data to/from either device 104 (e.g., a wireless DECT handset device) and/or a PTSN line. The selection applies to both directions (in/out) on a stream pipe 300a or 300b.

Included within message 400 is a destination identifier 402 and a source identifier 404. Destination identifier 402 identifies one of the channels 302. Source identifier 404 identifies the source of the isochronous data, such as, for example, device 104a or an external PTSN interface/line.

Message 400 can be exchanged between the computer and the hub, which are each configured to map the various channels 302 into stream pipe sets 300. The various embodiments in accordance with the present invention can be readily embodied in software, firmware and/or hardware logic/instructions within the connected devices, interfaces and/or related drivers.

As will be recognized by those skilled in the art, the innovative concepts described in the present application can be modified and varied over a wide range of applications. Accordingly, the scope of patented subject matter should not be limited to any of the specific exemplary teachings discussed.

What is claimed is:

1. An arrangement comprising:
a bus having at least one stream pipe configured to carry isochronous data transfers; and
at least two devices connected to the bus, each device being configured to send and receive the isochronous data transfers over the bus using different logical channels within the at least one stream pipe.

2. The arrangement as recited in claim 1, wherein the bus is a universal serial bus (USB).

3. The arrangement as recited in claim 2, wherein each of the at least two devices is further configured to be dynamically assigned to use one of a plurality of logical channels within the at least one stream pipe.

4. The arrangement as recited in claim 3, wherein the dynamic assignment to the one of a plurality of logical channels within the at least one stream pipe is established within the at least two devices using a channel assignment message.

5. The arrangement as recited in claim 4, wherein the channel assignment message is transferred using a control pipe in the bus.

6. The arrangement as recited in claim 5, wherein the channel assignment message comprises a destination identifier and a source identifier.

7. The arrangement as recited in claim 1, wherein each of the different logical channels within the at least one stream pipe is configured to carry at least eight bytes of a digitized voice sample.

8. The arrangement as recited in claim 7, wherein each of the at least eight bytes of digitized voice sample further comprises PCM formatted data as sampled from a voice signal in one millisecond intervals.

9. The arrangement as recited in claim 1, wherein the arrangement is a computer telephony system and the at least two devices includes at least two devices selected from a group of devices comprising a computer and a hub.

10. The arrangement as recited in claim 9, wherein at least one of the at least two devices selected from a group of devices comprising the computer and the hub, functions as base station configured to support voice communications through at least one wireless telephone device and at least one external telephone line.

11. An apparatus for connecting to a bus having at least one stream pipe configured to carry isochronous data transfers, the apparatus comprising means for selectively sending and receiving isochronous data transfers over the bus using different logical channels within the at least one stream pipe.

12. The apparatus as recited in claim 11, wherein the bus is a universal serial bus (USB).

13. The apparatus as recited in claim 12, wherein the means is further configured to be dynamically assigned to use one of a plurality of logical channels within the at least one stream pipe.

14. The apparatus as recited in claim 13, wherein the dynamic assignment to the one of a plurality of logical channels within the at least one stream pipe is established within the at least two devices using a channel assignment message.

15. The apparatus as recited in claim 14, wherein the channel assignment message is transferred using a control pipe in the bus.

16. The apparatus as recited in claim 15, wherein the channel assignment message comprises a destination identifier and a source identifier.

17. The apparatus as recited in claim 11, wherein each of the different logical channels within the at least one stream pipe is configured to carry at least eight bytes of a digitized voice sample.

18. The apparatus as recited in claim 17, wherein each of the at least eight bytes of digitized voice sample further comprises PCM formatted data as sampled from a voice signal in one millisecond intervals.

19. A method for supporting multiple simultaneous isochronous data transfers through a stream pipe in a universal serial bus (USB), the method comprising:
dividing a stream pipe into a plurality of channels;
dynamically assigning a first channel selected from the plurality of channels to a first device;
dynamically assigning a second channel selected from the plurality of channels to a second device;
transferring isochronous data within the first channel using the first device; and
simultaneously transferring isochronous data within the second channel using the second device.
